(19) United States
(12) Patent Application Publication
(10) Pub. No.: US 2019/0143347 A1
(43) Pub. Date: May 16, 2019

(54) SHOWER HEAD

(71) Applicant: GLOBE UNION INDUSTRIAL CORP., Taichung (TW)

(72) Inventors: Chun-Hung LI, TAICHUNG (TW); Hui-Ling CHIU, TAICHUNG (TW); Tun-Yao TSAI, TAICHUNG (TW)

(21) Appl. No.: 16/055,482

(22) Filed: Aug. 6, 2018

(30) Foreign Application Priority Data
Nov. 16, 2017 (CN) 201721528338

(51) Int. Cl. B05B 1/18

(52) U.S. Cl. CPC B05B 1/185; B05B 13/0278

(57) ABSTRACT

A shower head includes a housing, and a jet faceplate mounted to the housing and including a first water jetting area composed of a plurality of subunits and a second water jetting area having a second aperture therein. The subunits are arranged to present an arc-shaped distribution, each defining therein a plurality of first apertures. The subunits are in a fan-shaped area of the jet faceplate so that the water line of the ejected water can be concentrated and fan-shaped, enhancing the effect of removing dirt.

### BACKGROUND OF THE INVENTION

### 1. Field of the Invention

The present invention relates to the technical field of sanitary products and more particularly, to a shower head.

### 2. Description of the Related Art

With gradually increasing of people's living standards, people have also increasingly focused on quality of life. In terms of showers alone, people have begun to focus on the overall flow of water sprayed from the shower structure and the water-saving performance during showering. However, in addition to the poor spray water tactile sensation of conventional shower heads available on the market, the water-saving efficiency is greatly reduced due to the splashing of ejected water.

China Patent Publication No. CN106269323 A discloses a shower head entitled: “bundled fine water shower structure”, which comprises a housing (1), a jet faceplate (2), and a switching device (4) mounted on the housing (1) for controlling the water spray pattern of the jet faceplate (2). This design is characterized in that the jet faceplate (2) comprises a plurality of distributed water outlet units (24), and each water outlet unit (24) comprising an equal number of jet holes (241) in circular, oval, pentagonal, triangular or crescent shape, or any other regular or irregular shape, that is, the shape of each outlet unit (24) is surrounded by the same jet holes (241) into a regular or irregular shape and distributed over the jet faceplate (2). In summary, as described above, the “bundled fine water shower structure” achieves the effect of soft touch of jetted water that is not easy to splash as well as the effects of water-saving and applicability in low pressure environment.

However, this design of “bundled fine water shower structure” is not suitable for removing dirt. Under a low-pressure application environment, it cannot concentrate the water line to effectively focus the water line on the dirt. Therefore, the effect of cleaning dirt of this design of shower head is not obvious.

### SUMMARY OF THE INVENTION

The present invention has been accomplished under the circumstances in view. It is the main object of the present to provide a shower head, which is aimed to solve the technical problems of the prior art in which the water-saving effect of the shower head is not good.

To achieve this and other objects of the present invention, a shower head comprises a housing, a jet faceplate and a switching device. The housing has one end thereof configured for the connection of a shower tube or a water outlet of a water faucet. The jet faceplate is mounted to an opposite end of the housing, comprising an imaginary center, two imaginary radii extended from the imaginary center point to the periphery thereof for allowing the jet faceplate to be divided into a first fan-shaped region and a second fan-shaped region, a first water jetting area composed of a plurality of subunits, and a second water jetting area. Each subunit comprises a plurality of first apertures. The second water jetting area comprises a second aperture. The subunits of the first water jetting area are in the first fan-shaped region. The second water jetting area is in the second fan-shaped region. The switching device is mounted on the housing and operable to switch the water jetting mode of the switching device for causing the original water flowing out from the first water jetting area to be switched to flow out from the second water jetting area.

Preferably, the included angle of the first fan-shaped region formed using said imaginary center and the two imaginary radii is between 90° and 270°; the center of the second aperture of the second water jetting area is located at the center of gravity of the second fan-shaped region of the jet faceplate.

Preferably, the first apertures of each subunit are arranged in a radial arrangement or in a line; each aperture size of the first apertures is between 0.8 mm and 1.0 mm.

By means of arranging the subunits in a fan-shaped region of the jet faceplate to present an arc-shaped distribution, the water line of the ejected water can be concentrated and fan-shaped, effectively improving the water saving effect of the shower head and the effect of cleaning the dirt.

### BRIEF DESCRIPTION OF THE DRAWINGS

FIG. 1 is a schematic elevational view of a shower head in accordance with the present invention.

FIG. 2 is an exploded view of the shower head in accordance with the present invention.

FIG. 3 is a schematic applied view of a part of the shower head in accordance with the present invention.

FIG. 4 is another schematic applied view of a part of the shower head in accordance with the present invention.

FIG. 5 is still another schematic applied view of a part of the shower head in accordance with the present invention.

FIG. 6 is still another schematic applied view of a part of the shower head in accordance with the present invention.

FIG. 7 is a schematic front view of a part of the shower head in accordance with the present invention.

### DETAILED DESCRIPTION OF THE INVENTION

Other advantages and features of the present invention will be fully understood by reference to the following specification in conjunction with the accompanying drawings, in which like reference signs denote like elements, components, objects, structures, systems, architectures, means, flows, methods or steps.

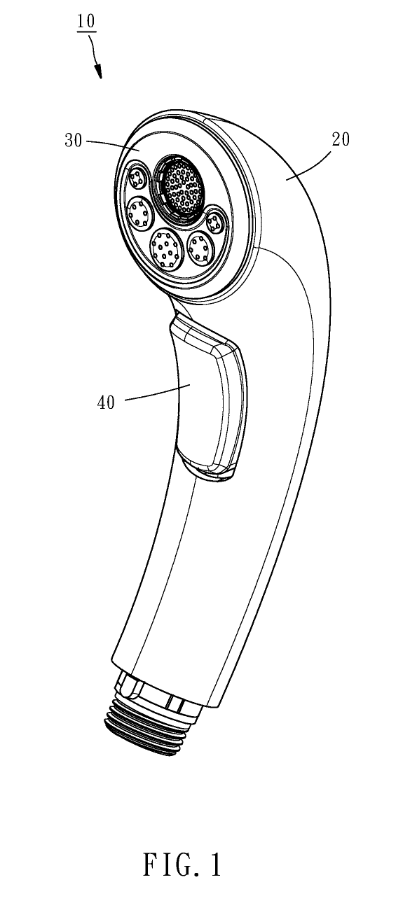

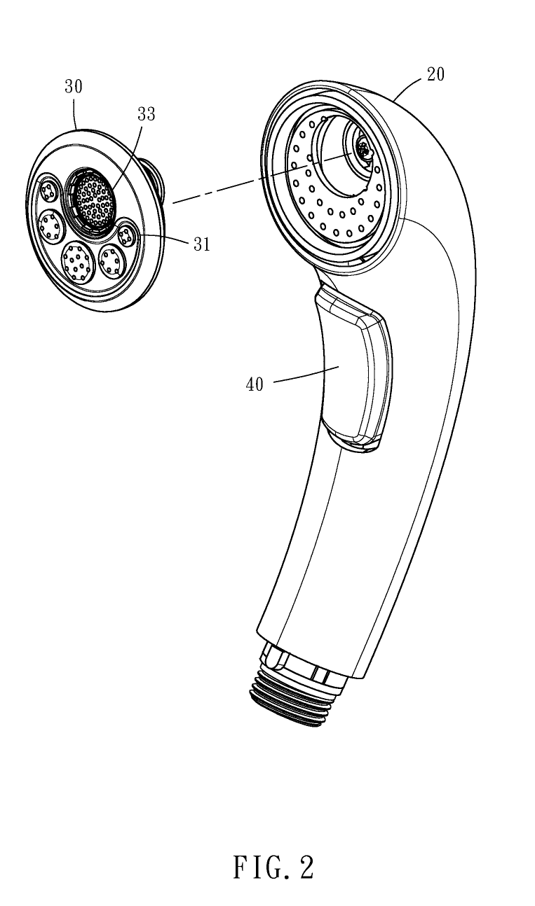

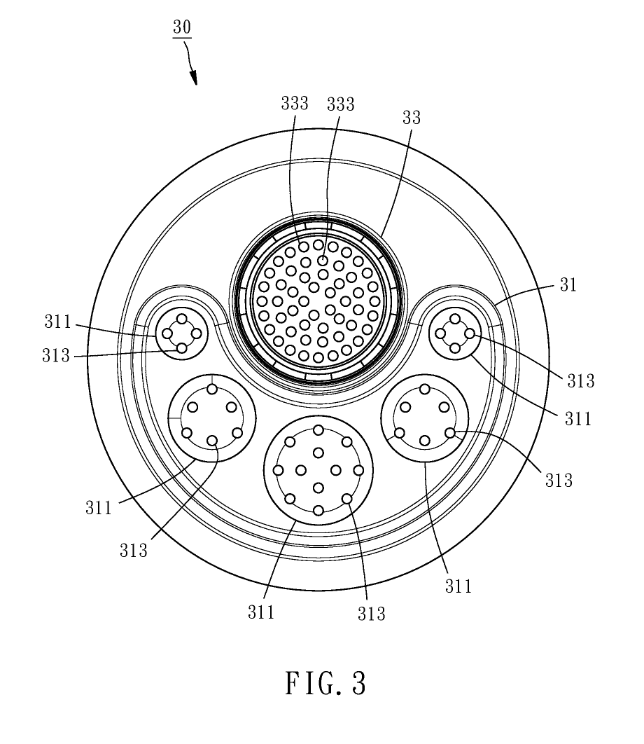

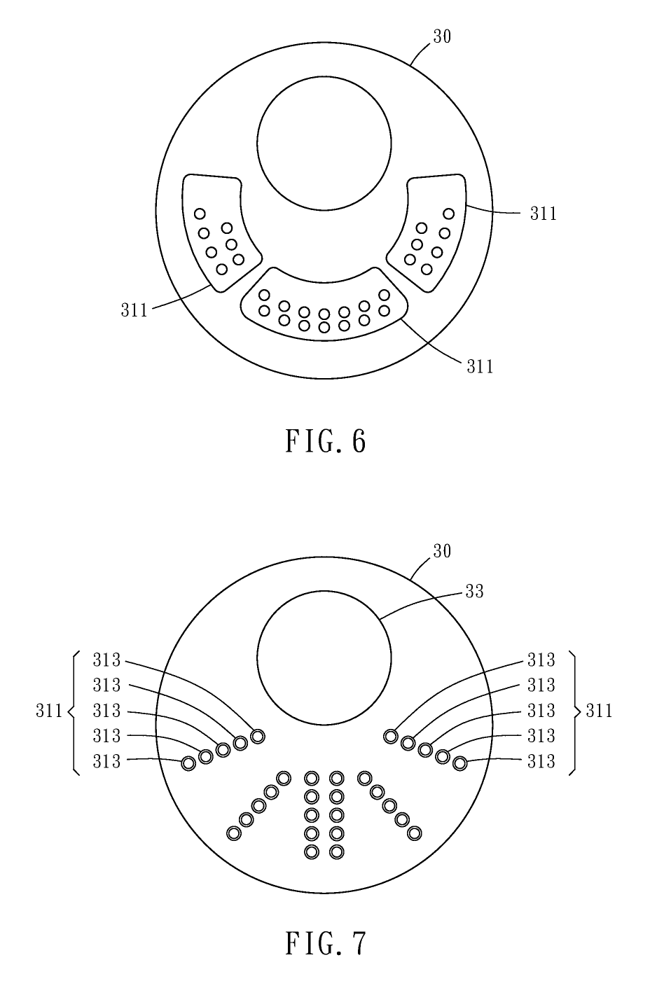

In the description of the present invention with reference to the annexed drawings of FIGS. 1-7, it should be understood that the orientated or positional terms “length”, “width”, “upper”, “lower”, “front”, “back”, “left”, “right”, “vertical”, “horizontal”, “top”, “bottom”, “inner”, “outer” and other indications are based on the orientation or positional relationship shown in the drawings, and is merely for convenience of description of the present invention and simplifying the description rather than indicating or implying that the device or component referred to must have a specific orientation or a construction and operation in a particular orientation, it cannot be interpreted as a limitation of the invention.

Referring to FIGS. 1-3, a shower head 10 in accordance with the present invention is shown. The shower head 10 comprises a housing 20, a jet faceplate 30, and a switching device 40. The jet faceplate 30 is mounted to one end of the housing 20. The switching device 40 is mounted on the periphery of the housing 20. The housing 20 is the main body of the shower head with the opposite end thereof configured for the connection of a shower tube or a water outlet of a water faucet. The switching device 40 is press able to control the water jetting mode of the jet faceplate 30.

The jet faceplate 30 is divided into a first water jetting area 31 and a second water jetting area 33. The first water jetting area 31 is composed of multiple subunits 311. Each subunit 311 is formed by a plurality of distributed first apertures 313. Preferably, the aperture of the equal and plurally distributed first apertures 313 is between 0.8 mm and 1.0 mm. The second water jetting area 33 is provided with a second aperture 333. When the user presses the switching device 40, the original water flowing out from the first water jetting area 31 is switched to flow out from the second water jetting area 31.

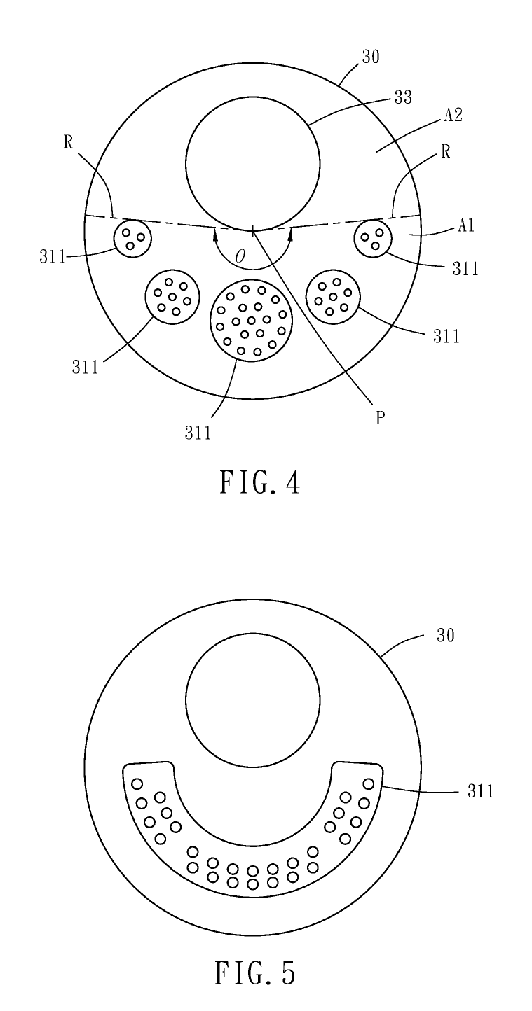

It is worth mentioning that, as shown in FIGS. 4-6, based on the fact that the jet faceplate 30 is a circle and based on the unit area thereof, an imaginary center P is set. The imaginary center point P of the jet faceplate 30 is a reference point and each extends to the periphery of the jet faceplate 30 to form two imaginary radii R, thereby allowing the jet faceplate 30 to be divided into two fan-shaped regions, namely, the first fan-shaped region A1 and the second fan-shaped region A2. The subunits 311 of the first water jetting area 31 are arranged in the first fan-shaped region A1 of the jet faceplate 30 to present an arc-shaped distribution. Preferably, a included angle θ of the first fan-shaped region A1 formed using the imaginary center P of the jet faceplate 30 as a reference point and the two imaginary radii R is between 90° and 270°. The second water jetting area 33 is located in the second fan-shaped region A2 of the jet faceplate 30. Preferably, the center of the second aperture 333 of the second water jetting area 33 is located at the center of gravity of the second fan-shaped region A2 of the jet faceplate 30.

It is worth mentioning that, as shown in FIG. 7, the jet faceplate 30 can also be an ellipse or a polygon; the plurality of first apertures 313 of any of the subunits 311 may be arranged in a radial arrangement or in a straight line; the second water jetting area 33 can be configured to provide a plurality of distributed second apertures 333.

According to the shower head 10 disclosed in the preceding embodiments of the present invention, the desired effects are as follows:
1. Since the equal and complexly distributed subunits 311 of the jet faceplate 30 of the shower head 10 are in one of the fan-shaped areas divided by the jet faceplate 30 to form the first water jetting area 31 of the jet faceplate 30, when pressing the switching device 40 to switch to the first water jetting area 31, the water line of the ejected water can be concentrated and fan-shaped. In this case, if compared to the “bundled fine water shower structure” in the China Patent Publication No. CN106269323 A, the water line with a fan shape in accordance with the present invention can be more prominently displayed for effectively removing dirt.
2. Since the subunits 311 of the first water jetting area 31 are arranged in the first fan-shaped region A1 of the jet faceplate 30 to present an arc-shaped distribution and the included angle θ of the first fan-shaped region A1 formed using the imaginary center P of the jet faceplate 30 as a reference point and the two imaginary radii R is between 90° and 270°, the user can easily prevent splashes when using the shower head 10. It is worth mentioning that the best included angle θ of the first fan-shaped region A1 is 120°.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A shower head, comprising:
a housing having one end thereof configured for the connection of a shower tube or a water outlet of a water faucet;
a jet faceplate mounted to an opposite end of said housing, comprising an imaginary center, two imaginary radii extended from said imaginary center point to the periphery thereof for allowing said jet faceplate to be divided into a first fan-shaped region and a second fan-shaped region, a first water jetting area composed of a plurality of subunits and a second water jetting area, each said subunit comprising a plurality of first apertures, said second water jetting area comprising a second aperture, said subunits of said first water jetting area being located in said first fan-shaped region, said second water jetting area being located in said second fan-shaped region; and
a switching device mounted on said housing and operable to switch the water jetting mode of said switching device for causing the original water flowing out from said first water jetting area to be switched to flow out from said second water jetting area.

2. The shower head as claimed in claim 1, wherein said subunits of said first water jetting area are arranged to present an arc-shaped distribution.

3. The shower head as claimed in claim 2, wherein a included angle of said first fan-shaped region formed using said imaginary center and said two imaginary radii is between 90° and 270°.

4. The shower head as claimed in claim 3, wherein the center of said second aperture of said second water jetting area is located at the center of gravity of said second fan-shaped region of said jet faceplate.

5. The shower head as claimed in claim 2, wherein the center of said second aperture of said second water jetting area is located at the center of gravity of said second fan-shaped region of said jet faceplate.

6. The shower head as claimed in claim 5, wherein at least two said second apertures are arranged in said second water jetting area.

7. The shower head as claimed in claim 1, wherein said first apertures of each said subunit are arranged in a radial arrangement.

8. The shower head as claimed in claim 1, wherein said first apertures of each said subunit are arranged in a line.

9. The shower head as claimed in claim 1, wherein each aperture size of said first apertures is between 0.8 mm and 1.0 mm.

10. The shower head as claimed in claim 2, wherein said first apertures of each said subunit are arranged in a radial arrangement.

11. The shower head as claimed in claim 2, wherein said first apertures of each said subunit are arranged in a line.

12. The shower head as claimed in claim 2, wherein each aperture size of said first apertures is between 0.8 mm and 1.0 mm.

13. The shower head as claimed in claim 3, wherein said first apertures of each said subunit are arranged in a radial arrangement.

14. The shower head as claimed in claim 3, wherein said first apertures of each said subunit are arranged in a line.

15. The shower head as claimed in claim 3, wherein each aperture size of said first apertures is between 0.8 mm and 1.0 mm.

16. The shower head as claimed in claim 4, wherein said first apertures of each said subunit are arranged in a radial arrangement.

17. The shower head as claimed in claim 4, wherein said first apertures of each said subunit are arranged in a line.

18. The shower head as claimed in claim 4, wherein each aperture size of said first apertures is between 0.8 mm and 1.0 mm.

19. The shower head as claimed in claim 5, wherein said first apertures of each said subunit are arranged in a radial arrangement.

20. The shower head as claimed in claim 5, wherein said first apertures of each said subunit are arranged in a line.

21. The shower head as claimed in claim 5, wherein each aperture size of said first apertures is between 0.8 mm and 1.0 mm.

22. The shower head as claimed in claim 6, wherein said first apertures of each said subunit are arranged in a radial arrangement.

23. The shower head as claimed in claim 6, wherein said first apertures of each said subunit are arranged in a line.

24. The shower head as claimed in claim 6, wherein each aperture size of said first apertures is between 0.8 mm and 1.0 mm.
